(19) United States
(12) Patent Application Publication
(10) Pub. No.: US 2015/0170435 A1
(43) Pub. Date: Jun. 18, 2015

(54) Intelligent, Cloud-Based, and Real-Time Vehicle Care System

(71) Applicant: POWER INTERNATIONAL CHEMICAL & OIL CORPORATION, Tainan (TW)

(72) Inventor: Po-Wen Ko, Tainan (TW)

(21) Appl. No.: 14/562,818

(22) Filed: Dec. 8, 2014

(30) Foreign Application Priority Data
Dec. 13, 2013 (TW) 102146192

(51) Int. Cl. G07C 5/00

(52) U.S. Cl. CPC G07C 5/008

(57) ABSTRACT

An intelligent, cloud-based and real-time vehicle care system has a vehicle diagnostic device, a remote server and a user device. The vehicle diagnostic device is mounted in a vehicle and has a control unit and a wireless transmission unit. When the control unit receives a trouble code from a diagnostic system or determines that the vehicle encounters trouble based on vehicle information received from a CAN bus system, the control module provides trouble diagnostic information to the remote server, and then the remote server transmits the trouble diagnostic information to the user device. Therefore, the user can operate the user device to review whether the vehicle encounters trouble in real-time.

### CROSS-REFERENCE TO RELATED APPLICATIONS

This application claims the benefit of Taiwan patent application No. 102146192, filed on Dec. 13, 2013, the disclosure of which is incorporated herein in its entirety by reference.

### BACKGROUND OF THE INVENTION

1. Field of the Invention

The present invention relates to an intelligent, cloud-based, and real-time vehicle care system for inspecting the vehicle for troubleshooting.

2. Description of Related Art

Taiwan patent publication No. 201110068 discloses a vehicle dynamic information system. A vehicle diagnostic system, such as an OBD-II (on-board diagnostics II) system, provides vehicle information including accumulated distance, driving speed, engine speed, engine temperature, radiator temperature, exhaust flow, etc. When the vehicle enters an intelligent parking lot, the vehicle dynamic information system communicates with a DSRC (dedicated short-range communication) communicator installed in the intelligent parking lot by DSRC wireless communication. The vehicle dynamic information system sends the above vehicle information to the DSRC communicator, and the DSRC communicator sends them to a back-end processor. The back-end processor receives and analyzes the vehicle information to obtain an analysis result. A user can connect a computer of a portable device to the back-end processor. Therefore, the user can use the computer or the portable device to review the analysis result to understand the vehicle health status and driving behavior.

However, the vehicle dynamic information system does not send out the vehicle information unless the vehicle enters the intelligent parking lot. Before the vehicle enters the intelligent parking lot, or when the vehicle enters a parking lot without the DSRC communicator, such vehicle information would not be transmitted. As a result, the user cannot acquire the instant information of the vehicle and fails to know the vehicle health status. For example, if the engine temperature or the radiator temperature is overheated, the user is not informed, causing inconvenience in driving.

### SUMMARY OF THE INVENTION

An objective of the present invention is to provide an intelligent, cloud-based, and real-time vehicle care system that receives any vehicle parameter in real-time and informs the user of unusual or abnormal vehicle parameter. Hence, the user is able to immediately and properly deal with such trouble the vehicle encountered.

The vehicle care system of the present invention mainly comprises a vehicle diagnostic device, a remote server and a user device. The vehicle diagnostic device is used to be mounted in a vehicle and has a control unit and a wireless transmission unit. The control unit comprises a first receiving module, a second receiving module and a control module. The first receiving module is used to communicate with a diagnostic system to receive one or more trouble codes from the diagnostic system. The second receiving module is used to communicate with a CAN (control area network) bus system to receive vehicle information from the CAN bus system. The control module communicates with the first receiving module, the second receiving module and the wireless transmission unit. When the control module receives the trouble code or determines that the vehicle encounters trouble based on the vehicle information, the control module generates and transmits trouble diagnostic information via the wireless transmission unit.

The remote server communicates with the wireless transmission unit of the vehicle diagnostic device and the user device to receive the trouble diagnostic information from the vehicle diagnostic device and transmit the trouble diagnostic information to the user device. The user device receives the trouble diagnostic information.

When the vehicle is started, the OBD-II system and the CAN bus system of the vehicle are booted to work. Compared with the prior art as mentioned above, regardless of the vehicle entering the intelligent parking lot or not, the first receiving module and the second receiving module of the present invention can obtain the trouble code from the OBD-II system or vehicle information from the CAN bus system in real-time. On condition that the OBD-II system sends out the trouble code or the control module determines that the vehicle information is unusual or abnormal, the vehicle care system of the present invention can provide the trouble diagnostic information to the remote server, and the remote server transmits the trouble diagnostic information to the user device at once, such that the user can be immediately informed that the vehicle encounters trouble. The conventional shortcomings, for example, the user fails to observe fault or trouble occurring to the vehicle during driving, are avoided.

Besides, the vehicle care system of the present invention takes data generated from both of the diagnostic system and the CAN bus system as a base for offering the trouble diagnostic information. Compared with the prior art that refers to information from no more than the OBD-II system, the vehicle care system of the present invention can improve accuracy of trouble diagnostic.

### BRIEF DESCRIPTION OF THE DRAWING

FIG. 1 is a circuit block diagram of the intelligent, cloud-base, and real-time vehicle care system of the present invention.

### DETAILED DESCRIPTION OF THE PREFERRED EMBODIMENT

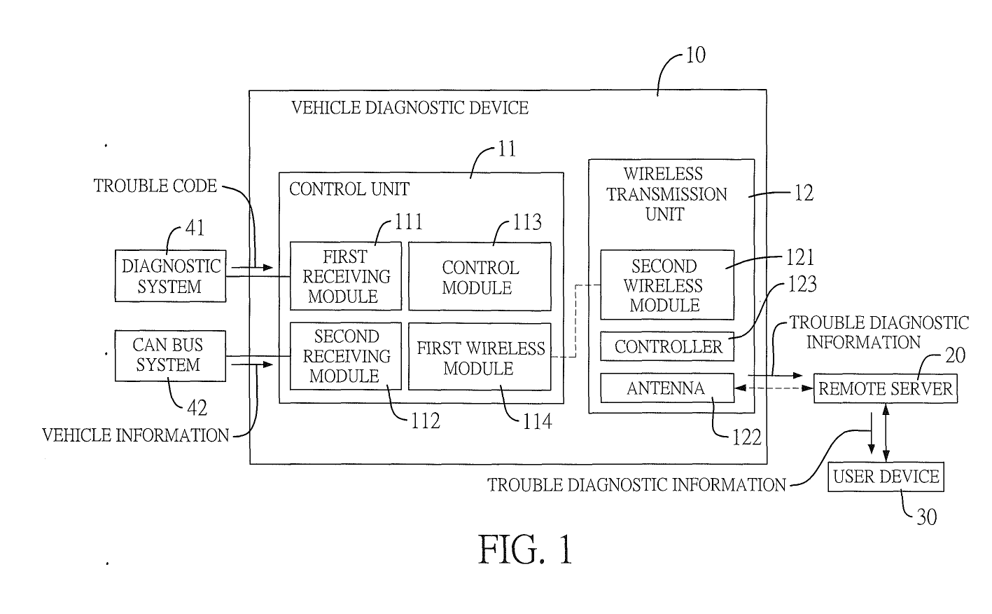

With reference to FIG. 1, the intelligent, cloud-based, and real-time vehicle care system of the present invention comprises a vehicle diagnostic device 10, a remote server 20 and a user device 30.

The vehicle diagnostic device 10 is adapted to be mounted in a vehicle. The vehicle is equipped with a diagnostic system 41 and a CAN (control area network) bus system 42. The diagnostic system 41 can be an OBD-II (On-board diagnostics II) system. The OBD-II system and the CAN bus system 42 are commonly seen in vehicles. The OBD-II system mainly detects whether the vehicle encounters trouble and accordingly generates one or more trouble codes when the trouble occurs. For example, when the OBD-II system detects that trouble happens to engine, the OBD-II system may correspondingly generate an engine trouble code. The CAN bus system 42 offers vehicle information including but not limited to accumulated distance, driving speed, engine speed, engine temperature, radiator temperature, exhaust flow, etc.

The vehicle diagnostic device 10 of the present invention comprises a control unit 11 and a wireless transmission unit 12.

The control unit 11 comprises a first receiving module 111, a second receiving module 112, a control module 113 and a first wireless module 114. The first receiving module 111 communicates with the diagnostic system 41. When the diagnostic system 41 generates the trouble code, the first receiving module 111 receives the trouble code from the diagnostic system 41. The second receiving module 112 communicates with the CAN bus system 42 to receive the vehicle information. The control module 113 connects to the first receiving module 111, the second receiving module 112 and the first wireless module 114 to receive the trouble code from the first receiving module 111 or receive the vehicle information from the second receiving module 112. When the control module 113 receives the trouble code, or determines that trouble happens to the vehicle after analyzing the vehicle information, for example the engine temperature or the radiator temperature is overheated, the control module 113 accordingly generates trouble diagnostic information and further transmits the trouble diagnostic information via the first wireless module 114.

The wireless transmission unit 12 comprises a second wireless module 121, an antenna 122 and a controller 123. The second wireless module 121 communicates with the first wireless module 114 by Bluetooth communication, NFC (near field communication) communication or other wireless communication protocols. The controller 123 connects to the second wireless module 121 and the antenna 122. When the controller 123 receives the trouble diagnostic information from the control unit 11 through the second wireless module 121, the controller 123 transmits the trouble diagnostic information via the antenna 122.

The remote server 20 can communicate with the antenna 122 of the wireless transmission unit 12 by GPRS (General Packet Radio Service) communication, GSM (Global System for Mobile Communications) communication, WCDMA (Wideband Code Division Multiple Access) communication, LTE (Long Term Evolution) communication or other wireless communication protocols to receive the trouble diagnostic information from the vehicle diagnostic device 10.

The user device 30 may be a smart phone, a tablet or other portable apparatuses. A user can operate the user device 30 to make a connection between the user device 30 and the remote server 20. When the remote server 20 obtains the trouble diagnostic information, the remote server 20 can automatically deliver the trouble diagnostic information to the user device 30 so that the user device 30 can display the trouble diagnostic information to inform. the user.

In conclusion, when the vehicle is started and the diagnostic system (OBD-II system) and the CAN bus system 42 are booted to work, the first receiving module 111 and the second receiving module 112 of the present invention can receive the vehicle information from the OBD-II system or the CAN bus system 42 in real-time. When the OBD-II system sends out the trouble code, or the control module 113 determines that the vehicle information sent from the CAN bus system 42 is unusual or abnormal, the vehicle care system of the present invention outputs the trouble diagnostic information to the user device 30 at once. Therefore, the user can be immediately informed whether the vehicle encounters trouble.

What is claimed is:

1. An intelligent, cloud-based, and real-time vehicle care system comprising a vehicle diagnostic device and a remote server, wherein
the vehicle diagnostic device is adapted to be mounted in a vehicle and has a control unit and a wireless transmission unit, and the control unit comprises:
a first receiving module for communicating with a diagnostic system to receive a trouble code from the diagnostic system;
a second receiving module for communicating with a CAN (control area network) bus system to receive vehicle information from the CAN bus system; and
a control module communicating with the first receiving module, the second receiving module and the wireless transmission unit, and generating and transmitting trouble diagnostic information via the wireless transmission unit when the control module receives the trouble code or determines that the vehicle has encountered trouble after analyzing the vehicle information; and
the remote server communicates with the wireless transmission unit of the vehicle diagnostic device to receive the trouble diagnostic information from the vehicle diagnostic device, and transmit the trouble diagnostic information to a user device;
the user device receives the trouble diagnostic information.

2. The vehicle care system as claimed in claim 1, wherein
the control unit Of the vehicle diagnostic device comprises a first wireless module communicating with the control module; and
the wireless transmission unit comprises
an antenna;
a second wireless module communicating with the first wireless module; and
a controller electrically connected to the second wireless module and the antenna to transmit the trouble diagnostic information via the antenna to the remote server when the controller receives the trouble diagnostic information from the control unit.

3. The vehicle care system as claimed in claim 2, wherein the first wireless module communicates with the second wireless module by Bluetooth communication.

4. The vehicle care system as claimed in claim 2, wherein the first wireless module communicates with the second wireless module by NFC (near field communication) communication.

5. The vehicle care system as claimed in claim 3, wherein the remote server communicates with the antenna of the wireless transmission unit by GPRS (General Packet Radio Service) communication, GSM (Global System for Mobile Communications) communication, WCDMA (Wideband Code Division Multiple Access) communication, or LTE (Long Term Evolution) communication.

6. The vehicle care system as claimed in claim 2, wherein the remote server communicates with the antenna of the wireless transmission unit by GPRS (General Packet Radio Servicer) communication, GSM (Global System for Mobile Communications) communication, WCDMA (Wideband Code Division Multiple Access) communication, or LTE (Long Term Evolution) communication.

7. The vehicle care system as claimed in claim 4, wherein the remote server communicates with the antenna of the wireless transmission unit by GPRS (General Packet Radio Service) communication, GSM (Global System for Mobile Communications) communication, WCDMA (Wideband Code Division Multiple Access) communication, or LTE (Long Term Evolution) communication.
